(19) United States
(12) Patent Application Publication
(10) Pub. No.: US 2020/0313128 A1
(43) Pub. Date: Oct. 1, 2020

(54) ACCUMULATOR MODULE

(71) Applicant: COMMEO GMBH, Wallenhorst (DE)

(72) Inventor: Michael SCHNAKENBERG, Wallenhorst (DE)

(21) Appl. No.: 16/310,815

(22) PCT Filed: Jun. 19, 2017
(86) PCT No.: PCT/EP2017/064983

§ 371 Date: Dec. 17, 2018

(30) Foreign Application Priority Data
Jun. 22, 2016 (DE) 20 2016 103 300.4

(51) Int. Cl. H01M 2/10; H01M 2/20; H01M 10/6551; H01M 2/02; H01M 2/30

(52) U.S. Cl. CPC H01M 2/1077; H01M 2/206; H01M 10/6551; H01M 2/30; H01M 2/204; H01M 2/024; H01M 2/1022

(57) ABSTRACT

The invention relates to an accumulator module (10) with a cuboidal outer contour having six surfaces, of which two oppositely situated surfaces function as front- and rear-side connection surfaces and/or alignment surfaces (12, 14), two further, oppositely situated surfaces function as a base surface and as a cover surface (20), and the remaining surfaces function as lateral surfaces (22, 24), wherein an accumulator module (10) is combinable, in each case via one of the connection surfaces and/or alignment surfaces (12, 14), with another accumulator module (10) and one of its connection surfaces and/or alignment surfaces (12, 14).

### BACKGROUND OF THE INVENTION

### Field of the Invention

The invention relates in general to a device, basically known per se, for storing electrical energy and for contacting energy storage cells included in the device, i.e., a device that functions as an energy store (energy storage device).

### Description of Related Art

DE 10 2012 213 273 A1 describes an energy storage device for a vehicle. Energy storage devices are generally used for a mobile power supply, for an emergency power supply, and the like.

The object of the present invention is to provide a compact, modular energy storage device, referred to below as an accumulator module.

### SUMMARY OF THE INVENTION

In summary, the invention proposes an accumulator module having one or more accumulator cells accommodated therein, and which is mechanically and electrically combinable with other similar or identical accumulator modules.

The above-mentioned object is achieved according to the invention by means of an accumulator module that functions as an energy storage device, having the features of claim 1. In such an accumulator module with a cuboidal outer contour having six surfaces, two oppositely situated surfaces function as front- and rear-side connection surfaces and/or alignment surfaces, two further, oppositely situated surfaces function as a base surface and as a cover surface, and the remaining surfaces function as lateral surfaces. Such an accumulator module is electrically and mechanically combinable, via one of the connection surfaces and/or alignment surfaces in each case, with another accumulator module and one of its connection surfaces and/or alignment surfaces, without the use of tools (tool-free).

The special feature of the accumulator module proposed here lies in the modularity resulting from the described electrical and mechanical combinability. One accumulator module may be combined with another accumulator module without tools, resulting in an electrical and mechanical/geometric unit. Via such a combination, it is possible, likewise without tools, to combine another accumulator module, and the resulting combination likewise forms an electrical and mechanical/geometric unit. In a cube-shaped accumulator module, a cuboidal train of accumulator modules is formed when multiple accumulator modules are combined as a mechanical/geometric unit. Such a train may in principle include any desired number of accumulator modules, for example two accumulator modules, three accumulator modules, four accumulator modules, etc.

An accumulator module of the type described above, sometimes referred to as a “cube” for short based on one possible, optional geometric basic shape, is the basis for a modularly expandable system for holding and storing electrical energy.

Due to the fact that an accumulator cell or a plurality of accumulator cells is present in the or each accumulator module, each accumulator module—each “cube”—may be understood and referred to as an energy block, and in any event functions as an energy storage device. The use of one or more such blocks comes into consideration in industry, in particular industrial manufacturing processes, in uninterruptible power supplies for the IT sector, in communication devices, in particular telecommunication devices, in vehicles, in particular electric vehicles or electric hybrid vehicles, as energy stores in conjunction with the generation and distribution of electrical energy based on use of renewable energies, and in the logistics sector, for example as an energy source for electrically operated forklifts, lift trucks, and the like.

Advantageous embodiments of the invention are the subject matter of the subclaims. Back-references that are used within the claims refer to the further development of the subject matter of the referenced claim by the features of the respective dependent claim. They are not to be construed as a waiver of the attainment of independent subject matter protection for the features or feature combinations of a dependent claim. Furthermore, with regard to an interpretation of the claims and an interpretation of the description, in the event of a more precise specification of a feature in a dependent claim, it is to be assumed that there is no such limitation in the respective preceding claims or in a more general embodiment of the accumulator module in question. Accordingly, any reference in the description to aspects of dependent claims, even without being specifically mentioned, is also to be explicitly construed as a description of optional features. Furthermore, it is pointed out that the claims filed with the present patent application are proposed formulations without prejudice to the attainment of further patent protection. Since in particular the features of the dependent claims, with regard to the prior art on the date of priority, may form separate, independent inventions, the applicant reserves the right to make these or even further feature combinations, heretofore disclosed only in the description and/or drawings, the subject matter of independent claims or declarations of division. Moreover, the features of the dependent claims may also include separate inventions that are independent from the subject matter of the respective referenced claims.

In one embodiment of the accumulator module, a first (front-side) connection profile/alignment profile is formed in its front-side alignment surface, and a second (rear-side) connection profile/alignment profile is formed in the rear-side alignment surface. By use of these connection profiles/alignment profiles, a first accumulator module is connectable to another accumulator module by combining the front-side connection profile of the first accumulator module with the rear-side connection profile of the other accumulator module, and by form-fit engagement of the front-side connection profile of the first accumulator module with the rear-side connection profile of the other accumulator module. The two connection profiles/alignment profiles form, in a manner of speaking, the two sides of a plug-in connection, and by means of these connection profiles/alignment profiles in each case two accumulator modules are connectable, without tools, to form a mechanical and geometric unit.

In one special embodiment of an accumulator module having connection profiles/alignment profiles that function in this way as the two sides of a plug-in connection, the first connection profile is recessed with respect to an enveloping surface of the accumulator module, and the second connection profile is correspondingly elevated, i.e., is designed for form-fit engagement with a first connection profile, recessed in this way, of another accumulator module. This is a comparatively simple profile shape, which, however, is characterized in that the underlying shapes are easily manufacturable, and also give the accumulator module an attractive appearance.

A connection profile/alignment profile which in this sense is easily manufacturable is characterized in that a border line of the first and second connection profiles/alignment profiles corresponds to the geometric shape of the border line of the accumulator module. Thus, for a cuboidal accumulator module having a rectangular or square border line, the border line of the first and second connection profiles/alignment profiles is also rectangular or square.

In one optional, preferred embodiment, the accumulator module in at least one of the two connection surfaces and/or alignment surfaces, optionally in both connection surfaces and/or alignment surfaces, has a terminal at least for electoconductively contacting the accumulator module, wherein the or each terminal is situated symmetrically with respect to a central longitudinal axis of the accumulator module extending centrally through the two connection surfaces and/or alignment surfaces. This allows particularly flexible electrical contactability of the accumulator module, in that an accumulator module with its base surface placed on a support surface is contactable in the same way as the accumulator module that is placed with its cover surface on the support surface (i.e., an “upside down” accumulator module).

In one special embodiment, a housing of the accumulator module that includes the base surface, the cover surface, and the two lateral surfaces is a section of a train profile. The housing is thus a one-piece housing. This promotes stability of the accumulator module. Separate installation of the lateral surfaces, included by the housing in one piece, is dispensed with, so that the installation of the accumulator module is also simplified.

In yet another embodiment of the accumulator module, the accumulator module includes a stacking profile in the base surface and/or the cover surface which is provided, for example, for stacking the accumulator module on at least one other accumulator module. It is thus possible not only to line up multiple accumulator modules (in one geometric direction), but also to combine them (in another geometric direction). By means of a stacking profile, the accumulator module may also be fixed on or at a storage surface, for example a shelf, or hung on a comparable surface. Fixing at, on, in, or under a machine, a machine part, a cabinet, a shelf, a stand, or the like is also suitable.

An accumulator module of the type described here and below functions alone as an energy storage device and electrical energy source, but is also in particular combinable with other accumulator modules, resulting in a system, having a plurality of accumulator modules, that likewise functions as an energy storage device and electrical energy source. The invention further relates to such a system, which due to being placeable in principle in a control cabinet or the like is referred to as a “rack” in the following description of the figures.

Such a system having a plurality of accumulator modules of the type described here and below is characterized in that within the system the accumulator modules are electroconductively connectable by means of individual module connectors, wherein the individual module connectors originate from a limited quantity of various preconfigured module connectors, and wherein a shortest module connector and a next longest module connector are in a fixed length ratio, for example a length ratio of 1:2, 1:2.5, 1:3, etc. The system includes a plurality of shortest module connectors of equal length and a plurality of next longest module connectors likewise of equal length. The length of the shortest module connectors and the length of the next longest module connectors depend on the distance between the accumulator modules in the system. In the system, the accumulator modules included therein are uniformly spaced apart, for example with a first, equal spacing within the system in the vertical direction and a second, likewise equal spacing within the system in the horizontal direction. A limited quantity of various module connectors (having various lengths) is possible due to such uniform spacing and the identical shape and geometry of all accumulator modules included in the system. The identical shape and geometry result in fixed, uniform spacing, in particular fixed minimal spacing. The shortest module connector is provided for bridging the minimal possible spacing in the system. The option for limiting the quantity of various module connectors is also facilitated by the terminals of the accumulator modules being situated symmetrically with respect to a central longitudinal axis of the accumulator module that extends centrally through the two alignment surfaces.

In one embodiment of such a system, rigid module connectors that are detachably connectable to two accumulator modules in each case and which at their ends bear contact elements that are optionally detachably connectable to the module connectors and are electrically and mechanically connectable to the terminals of an accumulator module in each case function as module connectors. Not only are the accumulator modules then electrically connectable to one another when they are sequentially aligned in a train in the manner of a plug-in system, but also the same plug-in system finds application in the connection of individual trains to one another by means of at least one module connector.

One exemplary embodiment of the invention is explained in greater detail below with reference to the drawings. Corresponding objects or elements are provided with the same reference numerals in all figures.

The exemplary embodiment is not to be construed as limiting to the invention. Thus, within the scope of the present disclosure, enhancements and modifications are also possible, in particular those that are apparent to those skilled in the art with regard to achieving the object of the invention, for example by combining or modifying individual features or method steps generally or specifically described in connection with the description section and contained in the claims and/or the drawings, and that by use of combinable features result in new subject matter or new method steps or method step sequences.

### BRIEF DESCRIPTION OF THE DRAWINGS

In the figures,

FIG. 1 shows an accumulator module,

FIG. 2 shows a combination of multiple accumulator modules,

FIG. 3 shows another embodiment of an accumulator module,

FIG. 4 shows yet another embodiment of an accumulator module,

FIG. 5 shows different electrical basic shapes of an accumulator module,

FIG. 6 shows basic shapes according to FIG. 5 in a switchable variant,

FIG. 7 shows an electrical equivalent circuit diagram of multiple interconnected accumulator modules, and

FIG. 8 and FIG. 9 show a system (rack) having a plurality of interconnected accumulator modules.

### DETAILED DESCRIPTION OF ILLUSTRATED EMBODIMENTS

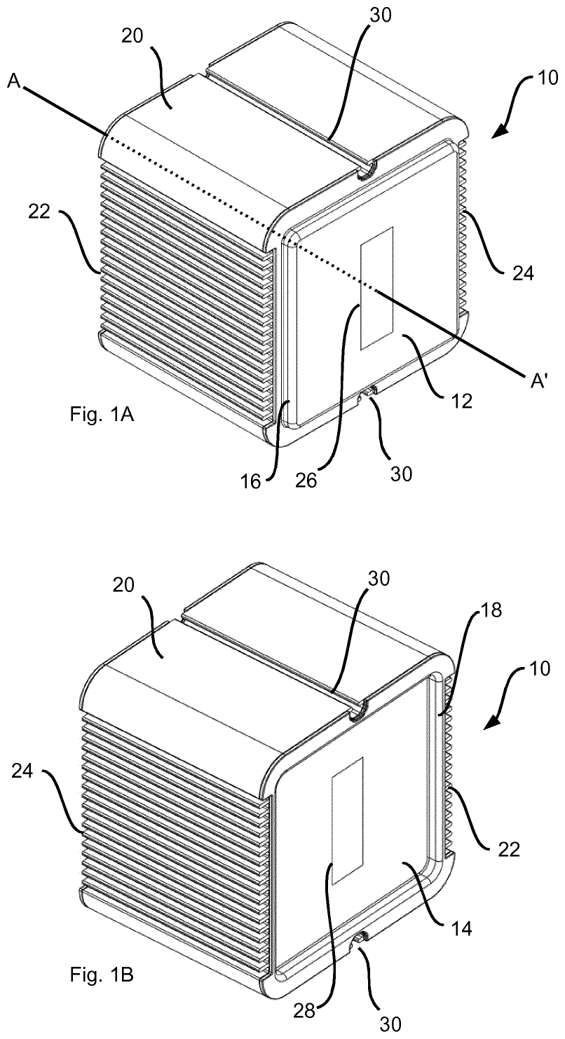

The illustration in FIG. 1 (FIGS. 1A, 1B) shows accumulator modules 10 from different views. The accumulator modules 10 in the exemplary embodiment are characterized by a cube-shaped geometry. Accordingly, an accumulator module 10 is sometimes also referred to below, expressly without waiver of further universality, as a cube for short (other geometries, in particular cuboidal geometries, may likewise be construed).

It is also apparent that the accumulator module 10 has six lateral surfaces, which for a cube are six lateral surfaces that are the same size or at least essentially the same size. Of these, two oppositely situated lateral surfaces function as connection sides/connection surfaces 12, 14. The connection surfaces 12, 14 are also alignment surfaces. Each connection side 12, 14 has an alignment profile/connection profile 16, 18. The illustration in FIG. 1A shows the accumulator module 10 with a view of a front-side connection side 12, and the illustration in FIG. 1B shows the accumulator module 10 with a view of a rear-side connection side 14.

Of the remaining four surfaces, two oppositely situated surfaces function as the base surface (concealed in FIGS. 1A, 1B) and as the cover surface 20. The two remaining surfaces form the lateral surfaces 22, 24. These lateral surfaces 22, 24 optionally have cooling ribs, or are designed with a rib-shaped surface structure or some other surface structure that increases the overall surface for purposes of heat dissipation. The stated surfaces 12, 14, 20, 22, 24 enclose a cavity in which one or more accumulator cells are situated, for example accumulator cells in the form of so-called round cells, and for example in an arrangement as described in the parallel patent application by the current applicant with application number PCT/EP2017/064979 and the title “Accumulator module having optimized current conduction,” and/or in an arrangement as described in the parallel patent application by the current applicant with application number PCT/EP2017/064982 and the title “Accumulator module having optimized heat dissipation.” By this reference, both patent applications are considered to be incorporated in full into the present description.

In one special embodiment, a housing that includes the base surface, the cover surface 20, and the two lateral surfaces 22, 24 is a section of a train profile. The stated surfaces 20, 22, 24 are then joined to one another in one piece, and in such a housing the housing is closed on both sides by the connection sides 12, 14.

At least one connection side 12, 14 of an accumulator module 10, optionally each connection side 12, 14, has a terminal 26, 28 for least electroconductively contacting the particular accumulator module 10. In one embodiment having only one terminal 26 in one connection side 12 (the front-side connection side 12), the rear surface is not a connection side, and the cavity delimited by the base surface and the cover surface 20 as well as by the lateral surfaces 22, 24 is closed by a blind cover on the side opposite from the front-side connection side 12.

In principle, each at least two-pole contact element or a combination of at least two contact elements that are in each case one-pole are suitable as the terminal 26, 28. For this reason, in the illustration in FIGS. 1A and 1B the terminals 26, 28 are shown only in a stylized manner and without particular details. The terminals 26, 28 are designed in such a way that the terminals 28 of another accumulator module 10 are contactable, without tools, by means of a terminal 26 of an accumulator module 10, for example by the terminals 26, 28 having a mutual form-fit design according to the plug-socket principle. However, it is important for the terminals 26, 28 to be situated symmetrically with respect to a central longitudinal axis A-A′ (shown in FIG. 1A) that extends centrally through the two connection sides 12, 14. This ensures that a terminal 28 of another accumulator module 10 is at least electrically and mechanically contactable by means of a terminal 26 of a first accumulator module 10, and conversely. This contactability in particular is also independent of whether the accumulator module 10 rests on the base surface, or whether the accumulator module 10 rests on the cover surface 20 (which then functions as the base surface). This contactability, when attained, thus allows rotation of an accumulator module 10 about its central longitudinal axis A-A′.

The imaginary line that extends through the center of both connection sides 12, 14, the central longitudinal axis A-A′, is also referred to below as the alignment axis. Multiple cubes (multiple accumulator modules 10) may be lined up with one another along this alignment axis A-A′, resulting in a train of lined-up cubes that are connected to one another by the alignment.

For connecting a cube to a neighboring cube via the alignment surfaces 12, 14 by lining them up, tool-free, detachable connectability in the manner of a plug-in system is optionally provided. For this purpose, it is provided, for example, that one of the two alignment surfaces 14 is recessed (lowered/indented), at least in sections, with respect to an enveloping contour of the cube, for example as shown in the embodiment according to FIG. 1 in the illustration in FIG. 1B, and that the alignment surface 12 on the opposite side of the cube is correspondingly elevated in sections, for example as shown in the embodiment according to FIG. 1 in the illustration in FIG. 1A. Thus, in such an embodiment each cube has a protruding (“male”) alignment surface 12 and a recessed (“female”) alignment surface 14. The resulting profile is the connection profile/alignment profile 16, 18. A male alignment profile 16 of a first cube is combinable, without tools, in a form-fit manner with a female alignment profile 18 of another cube, and conversely. Such a combination results in a sequential alignment of two cubes, and by possible addition of further cubes, results in a sequential alignment of a corresponding plurality of cubes, i.e., a cube train having two or more cubes (or a train having two or more accumulator modules 10). Optionally, a geometric shape of a border line of the alignment profiles 16, 18 of a cube corresponds to its basic geometric shape; thus, for a cube shape the border line of the alignment profiles 16, 18 is square.

The form-fit connection of two cubes via their correspondingly matching alignment profiles 16, 18 may form a detachable mechanical connection of the two cubes lined up with one another in this way, for example by means of detent elements, seals, or the like integrated into the alignment profiles 16, 18. Alternatively or additionally, a detachable mechanical connection in each case of two cubes lined up with one another may be established by means of at least one contact element of each terminal 26, 28 of the connection surfaces 12, 14.

Of course, a terminal having the correct polarity is necessary when multiple cubes/accumulator modules 10 are sequentially aligned. For this purpose, at least one of the poles (negative pole and/or positive pole) of the terminals 26, 28 is encoded so that only one permissible connection of the poles of one accumulator module 10 to the poles of the accumulator module 10 immediately following in the train is possible. Returning to the above-mentioned rotatability of each accumulator module 10 about its central longitudinal axis A-A′, this means that further accumulator modules 10 are connectable to a first accumulator module 10 only in the same rotational position (all cover surfaces 20 pointing in the same direction). In addition to such encoding of the terminals 26, 28, the terminals 26, 28 have a shockproof design, and the poles of the terminals 26, 28 have at least a spacing according to industry standards, for example a spacing of 40 mm, 60 mm, 80 mm, etc. In addition, the housing formed by the base surface, the cover surface 20, and the lateral surfaces 22, 24, together with the surfaces closing off the housing on the front and rear sides, has a shockproof design overall.

The electrical connection in each case of two cubes/accumulator modules 10 to one another is established entirely without tools and by “plugging in” their terminals 26, 28, namely, by plugging together contact elements of the terminals 26, 28 that function as power contacts. Optionally, these terminals 26, 28 include not only at least one power contact in each case for the two electrical poles, but also at least one contact element, which functions as a communication contact, for transmitting data and/or control signals. Such transmission takes place, for example, from one cube/accumulator module 10 to at least one other cube/at least one other accumulator module 10, from a cube/accumulator module 10 to a higher-order unit, and/or from such a higher-order unit to a cube/an accumulator module 10. The electrically conductive contacting of the accumulator modules 10 by means of the terminals 26, 28 then includes electrically conductive contacting of the power contacts and communication contacts included by the terminals 26, 28.

The terms “at least electrically conductive connection” or “at least electrical connection” of two accumulator modules 10 is understood to mean an electrically conductive connection of the power contacts, for example a connection of terminals 26, 28 that include only, or at least, power contacts. The terms “electrically conductive connection” or “electrical connection” of two accumulator modules 10 is understood to mean a connection of terminals 26, 28 that include either only power contacts, or also communication contacts in addition to power contacts.

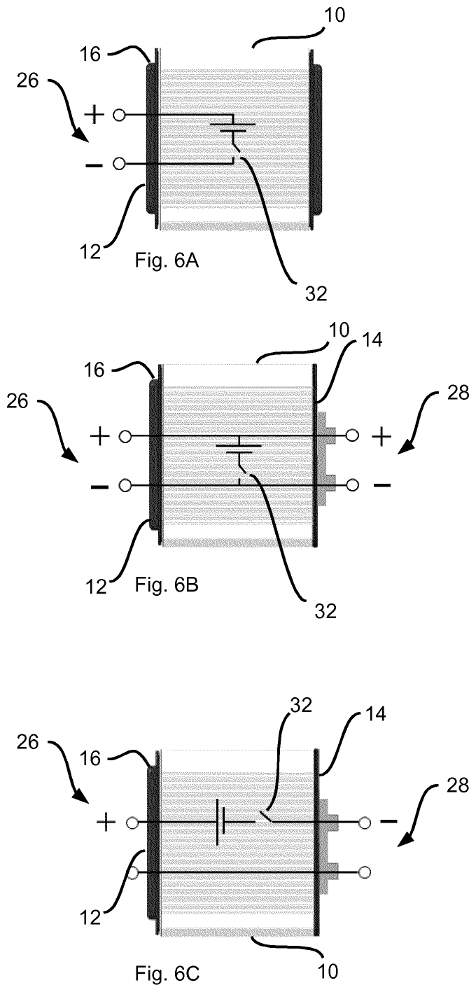

A communicative connection is designed, for example, in the form of a CAN bus or the like in a manner basically known per se, and each cube/each accumulator module 10 is an individually accessible communication user in a resulting network, for example a network in which all cubes/accumulator modules 10 communicatively connected to one another are of equal rank, or the higher-order unit functions as the master and each accumulator module 10 functions as a slave. An accumulator module 10 may be automatically activated or deactivated by means of such a communicative connection (for example, by controlling an optional switching element according to FIG. 6). Optionally, communication may take place using a battery management system (BMS), basically known per se, that is optionally included in each accumulator module 10, so that, for example, the data that are delivered by such a battery management system are usable for central evaluation and/or central control of multiple accumulator modules 10, and/or the influencing options provided by means of such a battery management systems, likewise basically known per se, are usable on the accumulator cells included in an accumulator module 10 (charge regulation, activation/deactivation of individual accumulator cells, etc.).

In the base surface and in the cover surface 20, in each case a profile is optionally formed centrally and in parallel to the above-mentioned central longitudinal axis A-A′. This profile allows a further detachable mechanical connection of a cube with another cube, namely, stacking of multiple cubes, and a detachable connection in each case of two cubes in the stacked state. In each case a cover surface 20 of one cube forms a base for placing a base surface of a neighboring cube thereon. For connecting two stacked cubes by means of the stated profiles, a connector is inserted into the profiles. In the following discussion, these profiles are referred to as stacking profiles 30 in order to distinguish them from the alignment profiles 16, 18.

Two or more cubes may be (vertically) detachably connected to one another in an arrangement one on top of the other by means of the stacking profiles 30. This vertical connectability is also combinable with the above-described modularity, i.e., connectability in the horizontal direction. Accordingly, one cube train may be placed on another cube train, and the two superposed trains (or two superposed trains in each case) may be detachably connected by inserting a connector into the stacking profile 30.

By means of the stacking profile 30, a cube is also detachably fixable to a support structure (upright or hanging), or with a vertically oriented base surface and cover surface 20 is also fixable to a support structure. Control cabinets or the like, as well as machines or machine parts, vehicles or vehicle parts, etc., are suitable as support structures.

A cube of the type described above, or in general an accumulator module 10 having a more general geometry, in particular a cuboidal geometry, is the basis for a modularly expandable system for holding and storing electrical energy. A housing that includes the base surface, the cover surface 20, and the two lateral surfaces 22, 24 is optionally a section of a train profile.

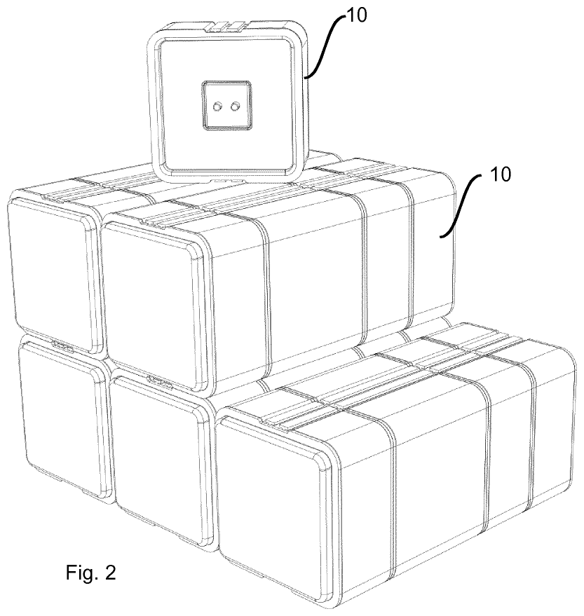

The illustration in FIG. 2 shows a combination of a plurality of cubes (accumulator modules 10). In each case a plurality of cube trains is present in two layers. Each cube train is a sequential alignment of multiple cubes. A single cube is present on top of the second layer. It is pointed out that the arrangement shown is strictly an example, and the cubes in particular are combinable in any desired manner.

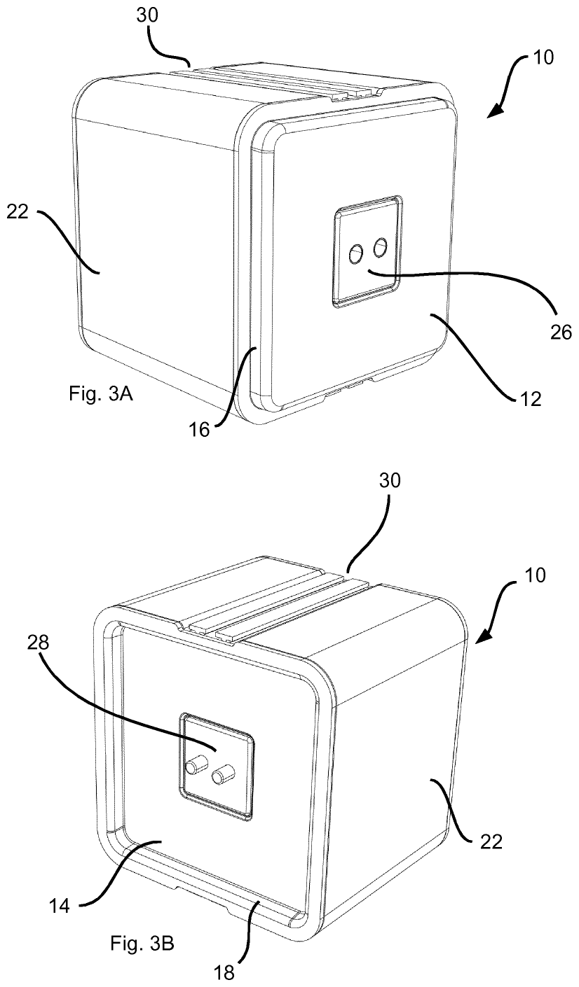

The illustration in FIG. 3 (FIGS. 3A, 3B) shows a single cube with a view of one of its connection surfaces 12, 14. The illustration in FIG. 3A shows the (recessed) connection profile 16 at that location. Situated in the center of the connection profile 16 is a contact element, having two plugs, as an example of a terminal 26 of the accumulator module 10. The illustration in FIG. 3B shows the (elevated) connection profile 18 on the oppositely situated connection surface 14. A socket-shaped contact element with which the plugs of another cube can engage is situated at that location, in the center.

The connection profiles 16, 18 are combinable with one another in a form-fit manner. The terminals 26, 28 are combinable with one another in a form-fit manner. Another cube having the connection surface 14 shown in FIG. 3B is thus combinable with a cube according to FIG. 3A having the connection surface 12 shown there. The terminals 26, 28 are situated in the center of the connection surfaces 12, 14, and have a symmetrical design (point symmetrical with respect to the central longitudinal axis A-A′). This results in a detachable mechanical combination due to the connection profiles 16, 18, and a detachable electrical combination due to the terminals 26, 28. This situation, namely, the combinability due to the connection profiles 16, 18 and/or the terminals 26, 28, exists regardless of the specific embodiment shown, and is the central feature of an accumulator module 10 according to the approach presented here.

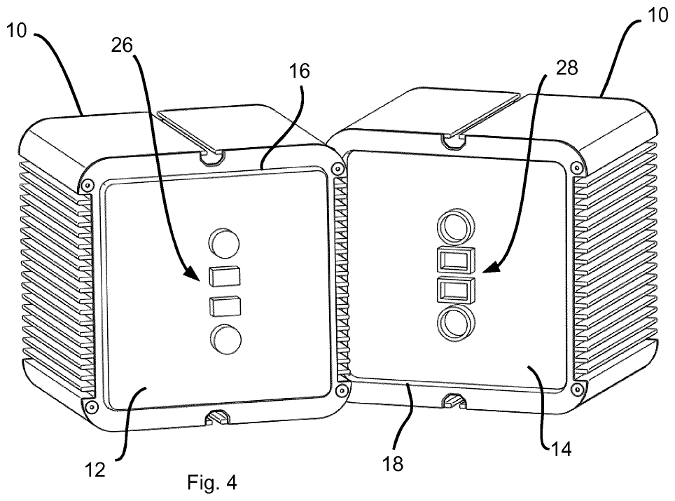

The illustration in FIG. 4 shows two cubes (accumulator modules 10) that are placed next to one another in such a way that their different connection surfaces 12, 14 are discernible. Compared to the embodiment according to FIGS. 2 and 3, these cubes have different terminals 26, 28—only to illustrate that various terminals 26, 28 are possible. These terminals 26, 28 are also situated in the center of the connection surfaces 12, 14, and have a symmetrical design (point symmetrical with respect to the central longitudinal axis A-A′). In the terminals 26, 28 shown, for example the contact elements illustrated as circles function as power contacts, and the contact elements illustrated as rectangles function as communication contacts. It is apparent that the contact elements are in each case combinable with one another, without tools, in a form-fit manner in the manner of a plug-socket combination and detachably combinable with one another. The mentioned, in principle optional, encoding of the terminals 26, 28 is not shown in the illustration in FIG. 4 for the sake of clarity, and may be designed, for example, as an inwardly pointing “nose” in a, or each, contact element illustrated as a hollow cylinder, and a corresponding recess in the, or each, contact element illustrated as a cylinder.

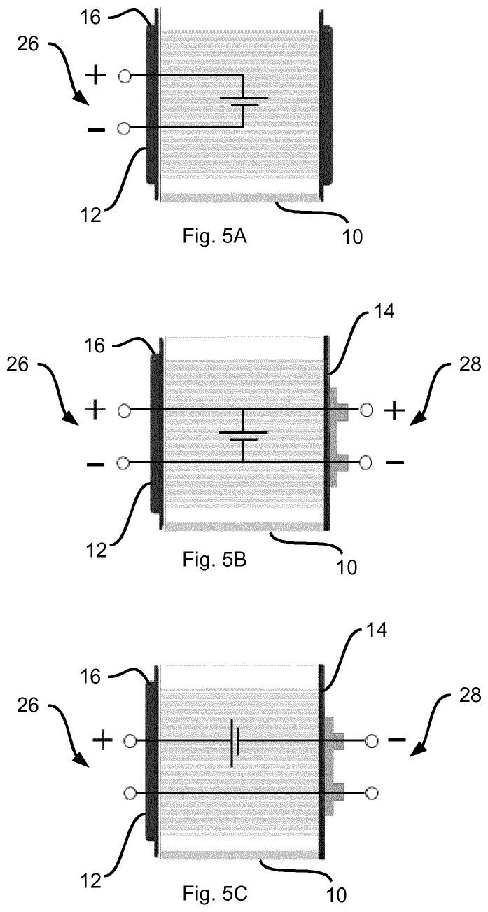

The illustration in FIG. 5 (FIGS. 5A, 5B, 5C) schematically shows in a simplified manner the function of the accumulator module 10 as an energy storage device and as an electrical energy source. An accumulator cell included in an accumulator module 10, and, for a plurality of accumulator cells, the entirety of the accumulator cells included in an accumulator module 10, is shown by the circuit symbol for a galvanic cell.

An accumulator module 10 according to FIG. 5A may be used alone as a current or voltage source (only the property of the accumulator module 10 as a voltage source is discussed below, as necessary; of course, a function as a current source or in general as an energy source is to construed in each case). Due to the above-described modularity, an accumulator module 10 according to FIG. 5A may be combined, for example with an accumulator module 10 according to FIG. 5B or with an accumulator module 10 according to FIG. 5C. The accumulator modules 10 are arranged in succession in a train-like manner in such a way that a rear connection surface 14 of one accumulator module 10 faces a front-side connection surface 12 of an accumulator module 10 that follows in the resulting train. The number of preceding accumulator modules 10 in the train either according to FIG. 5B or alternatively according to FIG. 5C is in principle arbitrary. When multiple accumulator modules 10 according to FIG. 5B are interconnected to a terminating accumulator module 10 according to FIG. 5B, a parallel connection is created, resulting in a current, tappable at the input of the train of the interconnected accumulator modules 10, that is equal to the sum of the currents that are outputtable by the individual accumulator modules 10. When multiple accumulator modules 10 according to FIG. 5C are interconnected with a terminating accumulator module 10 according to FIG. 5A, a series connection is created, resulting in a voltage, tappable at the input of the train of the interconnected accumulator modules 10, that is equal to the sum of the individual voltages of each accumulator module 10.

The illustration in FIG. 6 (FIGS. 6A, 6B, 6C) shows switchable variants of the accumulator modules 10 according to FIGS. 5A, 5B, and 5C. In a switchable variant, the particular accumulator module 10 includes a switching element 32, in particular an electrically controllable switching element 32, for example a switching element 32 in the form of a relay. The accumulator module 10 (the or each accumulator cell included therein) in a circuit that includes the accumulator module 10 may be activated or deactivated by means of such a switching element 32. For a plurality of accumulator modules 10 that are combined and interconnected in a train, each individual accumulator module 10 may be activated or deactivated.

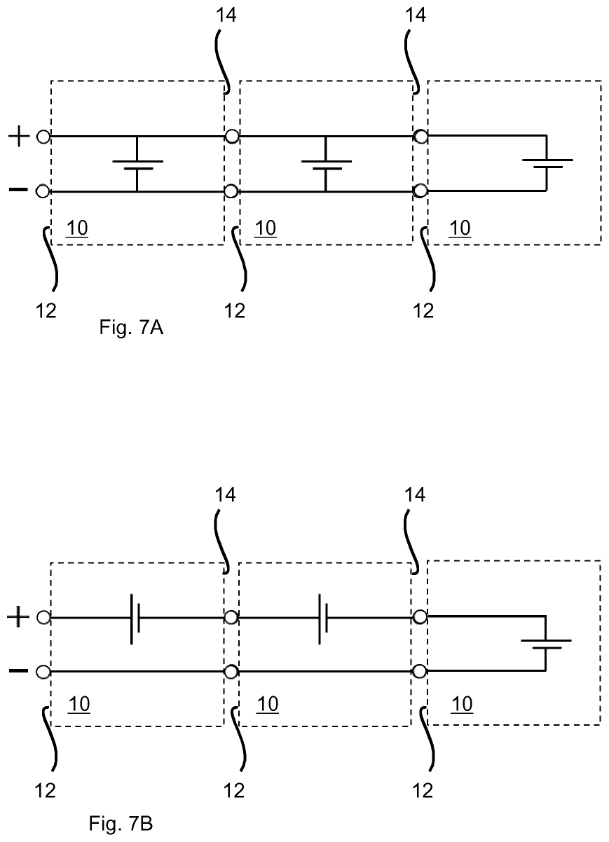

The illustration in FIG. 7 (FIGS. 7A, 7B) shows examples of individual connections of multiple accumulator modules 10. The illustration in FIG. 7A shows a parallel connection of multiple accumulator modules 10, namely, a parallel connection of two accumulator modules 10 according to FIG. 5B and a terminating accumulator module 10 according to FIG. 5A. The illustration in FIG. 7B shows a series connection of multiple accumulator modules 10, namely, a series connection of two accumulator modules 10 according to FIG. 5C and a terminating accumulator module 10 according to FIG. 5A. Switchable accumulator modules 10 according to FIG. 6 are also possible instead of the nonswitchable accumulator modules 10 shown. In the interconnection according to FIG. 7A (parallel connection), three times the maximum current that is deliverable by each individual accumulator module 10 is tappable at the input of the resulting train. In the interconnection according to FIG. 7B (series connection), three times the nominal voltage of each individual accumulator module 10 is tappable at the input of the resulting train. For more than three accumulator modules 10 in an interconnection in the form of a parallel connection or a series connection, the multiplicative increase in the tappable voltage or the tappable current correspondingly applies (four times the voltage or four times the current with four accumulator modules 10; five times the voltage or five times the current with five accumulator modules 10, etc.).

The accumulator modules 10 according to FIG. 5 or according to FIG. 6 represent combinable single modules that are suitably and flexibly combinable, depending on the energy requirement in each case. For a parallel connection, the resulting train may in principle include any desired number of modules according to FIG. 5B/FIG. 6B, and the particular train is terminated by a module according to FIG. 5A. The same correspondingly applies for a series connection. Such a train may in principle have any desired number of modules according to FIG. 5C/FIG. 6C, and the particular train is terminated by a module according to FIG. 5A.

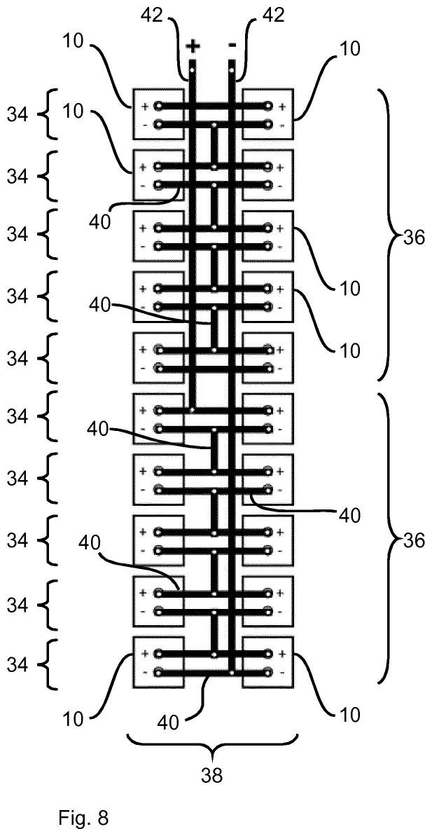

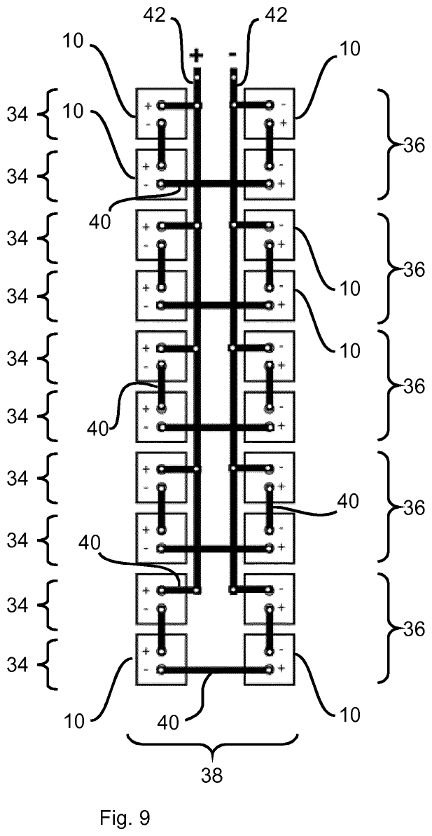

The illustrations in FIGS. 8 and 9 show the flexibility that results when a plurality of accumulator modules 10 is interconnected. The illustrations in FIGS. 8 and 9 schematically show in a simplified manner a top view of multiple accumulator module trains situated next to and on top of one another, also referred to below as trains for short. Of each train, only the connection-side accumulator module 10 is visible. Single accumulator modules 10 are denoted by the appropriate reference numerals in the illustrations. Each train may include a plurality of accumulator modules 10. It is meaningful for all trains combined according to FIG. 8 or FIG. 9, or a similar configuration, to have the same number of accumulator modules 10 in each case.

It is apparent that the interconnection in multiple planes 34 includes two interconnected trains in each case. Two or more planes 34 may be combined in each case to form a plane combination 36. Multiple plane combinations 36 may likewise be combined. This combination is referred to as a rack 38, and the entirety of the accumulator modules 10 included therein may be placed, for example, in or on a shelf-like frame having a plurality of superposed levels, in particular a so-called control cabinet having such levels or corresponding support surfaces, wherein the levels function as a support surface for the accumulator modules 10, and/or the accumulator modules 10 are hung on such levels or hung on structural elements that allow such suspension.

The connection takes place by means of rigid, pluggable module connectors 40, only some of which are denoted in the illustrations in FIGS. 8 and 9. The module connectors 40 are rigid conductor sections that on their ends bear contact elements (not shown) which, in particular in the manner of a plug-socket connection, correspond to the terminals 26, 28 of the accumulator modules 10. The module connectors 40 are in each case thus connectable on one side to a terminal 26, 28 of an accumulator module 10, and each terminal 26, 28 of another accumulator module 10 is similarly connectable to the terminal 26, 28 in question. Electrically conductive connection points to one of the terminals 26, 28 of an accumulator module 10 or to another module connector 40 or a busbar 42 are shown in FIGS. 8 and 9 in the form of a white dot in the surface of the module connector 40 or the busbar 42. At intersection points of two module connectors 40 or of one module connector 40 and one busbar 42 without such a white point, there is no electrically conductive connection, for example because the module connectors 40 or busbars 42 in question are spaced apart from one another in different (spatial) planes.

A contact element at the end of a module connector 40 that is connectable to a first terminal 26 of an accumulator module 10 preferably corresponds to a second terminal 28, which otherwise is situated on another accumulator module 10. Likewise, a contact element at the end of a module connector 40 that is connectable to a second terminal 28 of an accumulator module 10 preferably corresponds to a first terminal 26, which otherwise is situated on another accumulator module 10. In any case, the contact elements of the module connectors 40 in each case have at least power contacts for contacting the power contacts of the terminals 26, 28, and optional power contacts for contacting the power contacts of the terminals 26, 28, as well as communication contacts for contacting the communication contacts of the terminals 26, 28. The connection of a contact element of a module connector 40 to a terminal 26, 28 optionally takes place without tools, the same as for the connection of two accumulator modules 10 via their terminals 26, 28 without tools. This tool-free connection of a module connector 40 to an accumulator module 10 is also detachable without tools.

The rigid conductor sections that form the basis of the module connectors 40 are, for example, sections of a copper bar having a rectangular cross section, i.e., sections of a copper bar which otherwise are also suitable as a busbar. Other conductor materials and other profile shapes are also possible in principle.

The module connectors 40 of a rack 38 are optionally provided in fixed length ratios. If the length of the shortest module connector 40 is taken as the base length, the next longest module connector 40 has a length that corresponds to x times the base length. A module connector 40 possibly requiring an even greater length has a length that corresponds to y times the base length, etc., where x and y are natural or rational numbers. In the example shown in FIG. 9, the module connectors 40 having the next longest length compared to the base length have, for example, a length of approximately 2.5 times the base length.

Busbars 42 that extend along the rack 38 are provided for the terminating contacting of the module connectors 40. This allows optional tool-free connection of all module trains to one another in basically any desired configurations, in that the module connectors 40 or the busbars 42 are connected to the terminals 26, 28 of each front-side accumulator module 10 of a module train, in particular placed on these terminals 26, 28.

The connection of the accumulator modules 10 included in the rack 38 shown in FIG. 8 is a 2 p (5 s (2 p ( . . . ))) connection. This notation is read as follows:
2×parallel connections of two plane combinations 36

each with 5 planes 34 connected in series

each with 2 module trains connected in parallel

each with . . . accumulator modules 10 in each module train connected in series or parallel.

The number of accumulator modules 10 in each module train is in principle arbitrary, and each train may include one accumulator module 10, two accumulator modules 10, three accumulator modules 10, etc. This is expressed by the placeholder symbol “ . . . ”.

The connection of the accumulator modules 10 included in the rack 38 shown in FIG. 9 is a 5 p (2 s (2 s ( . . . ))) connection. This notation is read as follows:
5×parallel connections of five plane combinations 36

each with 2 planes 34 connected in series

each with 2 module trains connected in parallel

each with . . . accumulator modules 10 in each module train connected in series or parallel.

Here as well, the number of accumulator modules 10 is in principle arbitrary (notation: “ . . . ”).

For exactly three accumulator modules 10 in each train connected in series and a nominal voltage U_{module} of a single accumulator module 10 of 50 V, this results in a tappable voltage U_{rack} at the rack 38 according to FIG. 9 as U_{rack}=(2×2×3)×U_{module}=(2×2×3)×50 V=600 V.

The connectability of accumulator modules 10 to form planes 34, plane combinations 36, and a resulting rack 38, shown in FIGS. 8 and 9, are strictly examples, and in addition to the options shown, an immense number of further connection options are conceivable. Of course, a rack 38 may also include more or fewer than the ten planes 34 shown in the figures, and multiple racks 38 are likewise naturally combinable to obtain an even higher voltage, an even higher maximum current, and/or an even higher electrical power.

The user of one or more racks 38 may individually configure the or each rack 38, thus obtaining a basically mobile energy storage device that is independent from a power supply grid, and that is adapted to the particular needs with regard to voltage, maximum current, and power. The underlying flexible connectability of the accumulator modules 10 or of the front-side accumulator modules 10 in the individual trains by means of the module connectors 40 also results in particular due to the symmetrical arrangement of the terminals 26, 28 in the connection surfaces 12, 14 of the accumulator modules 10. As mentioned above, the terminals 26, 28 are placed centrally in the connection surfaces 12, 14 and point symmetrically with respect to the central longitudinal axis A-A′. This allows the different placement of the accumulator modules 10 (or entire module trains), as shown in FIGS. 8 and 9.

All accumulator modules 10/module trains have the same orientation in the illustration in FIG. 8. The negative pole is always on bottom. The positive pole is always on top. In the illustration in FIG. 9, the accumulator modules 10/module trains have different orientations. On the left side of the rack 38 the negative poles are on bottom and the positive poles are on top. In contrast, on the right side of the rack the negative poles are on top and the positive poles are on bottom. This “rotatability” of the accumulator modules 10/module trains, when connectability is attained with module connectors 40 having fixed lengths, is possible only due to the central and symmetrical arrangement of the terminals 26, 28. The notation with the directional information “on bottom” and “on top” is intended to indicate that reference is made here to the graphical illustration in the figures, and for a nonvertically oriented rack 38, the directional indications are to be correspondingly replaced with other directional indications.

Although the invention has been illustrated and described in greater detail with reference to the exemplary embodiment, the invention is not limited to the disclosed example(s), and other variations may be derived therefrom by those skilled in the art without departing from the protective scope of the invention.

Individual key aspects of the description provided herein may thus be briefly summarized as follows: The invention relates to an accumulator module 10 with a cuboidal outer contour having six surfaces, of which two oppositely situated surfaces function as front- and rear-side connection surfaces and/or alignment surfaces 12, 14, two further, oppositely situated surfaces function as a base surface and as a cover surface 20, and the remaining surfaces function as lateral surfaces 22, 24, wherein an accumulator module 10 is combinable, in each case via one of the connection surfaces and/or alignment surfaces 12, 14, with another accumulator module 10 and one of its connection surfaces and/or alignment surfaces 12, 14.

### LIST OF REFERENCE NUMERALS

10 accumulator module 12 (front-side) connection side/connection surface 14 (rear-side) connection side/connection surface 16 alignment profile/connection profile 18 alignment profile/connection profile 20 cover surface 22 lateral surface 24 lateral surface 26 terminal 28 terminal 30 stacking profile 32 switching element 34 plane 36 plane combination 38 rack 40 module connector 42 busbar

1. An accumulator module (10) with a cuboidal outer contour having six surfaces, of which two oppositely situated surfaces function as front- and rear-side alignment surfaces (12, 14), two further, oppositely situated surfaces function as a base surface and as a cover surface (20), and the remaining surfaces function as lateral surfaces (22, 24),
wherein an accumulator module (10) is electrically and mechanically combinable, in each case via one of the alignment surfaces (12, 14), with another accumulator module (10) and one of its alignment surfaces (12, 14).

2. The accumulator module (10) according to claim 1,
wherein a first connection profile (16) is formed in the front-side alignment surface (12) and a second connection profile (18) is formed in the rear-side alignment surface (14) and
wherein a first accumulator module (10) is connectable to another accumulator module (10) by combining the first connection profile (16) of the first accumulator module (10) with the second connection profile (18) of the other accumulator module (10).

3. The accumulator module (10) according to claim 2,
wherein the first connection profile (16) is recessed with respect to an enveloping surface of the accumulator module (10) and
wherein the second connection profile (18) is designed for form-fit engagement with a first connection profile (16), recessed in this way, of another accumulator module (10).

4. The accumulator module (10) according to claim 2, wherein a border line of the first and second connection profiles (16, 18) corresponds to a border line of the accumulator module (10).

5. The accumulator module (10) according to claim 1,
wherein each alignment surface (12, 14) has a terminal (26, 28) for electroconductively contacting the accumulator module (10) and
wherein the terminals (26, 28) are situated symmetrically with respect to a central longitudinal axis of the accumulator module (10) that extends centrally through the two alignment surfaces (12, 14).

6. The accumulator module (10) according to claim 1,
wherein a housing that includes the base surface, the cover surface (20), and the two lateral surfaces (22, 24) is a section of a train profile.

7. The accumulator module (10) according to claim 1,
having a stacking profile (30) in the base surface and/or the cover surface (20).

8. A system (38) having a plurality of accumulator modules (10) according to claim 1,
wherein within the system the accumulator modules (10) are electroconductively connectable by means of individual module connectors (40) and
wherein the system includes a plurality of shortest module connectors (40) of equal length and a plurality of next longest module connectors (40) likewise of equal length.

9. The system (38) according to claim 8,
wherein rigid module connectors (40) that are detachably connectable to two accumulator modules (10) in each case function as module connectors (40) and
wherein each module connector (40) at its ends bears contact elements that are electrically and mechanically connectable to the terminals (26, 28) of an accumulator module (10) in each case.

10. An electrical device having at least one accumulator module according to claim 1.

11. The accumulator module (10) according to claim 3, wherein a border line of the first and second connection profiles (16, 18) corresponds to a border line of the accumulator module (10).
